(19) United States
(12) Patent Application Publication
(10) Pub. No.: US 2020/0107987 A1
(43) Pub. Date: Apr. 9, 2020

(54) METHOD AND DEVICE FOR TREATMENT OF APHTHOUS ULCERS

(71) Applicant: Timothy Murphy, Providence, RI (US)

(72) Inventor: Timothy Murphy, Providence, RI (US)

(21) Appl. No.: 16/152,932

(22) Filed: Oct. 5, 2018

(51) Int. Cl. A61H 21/00; A61H 9/00

(52) U.S. Cl. CPC A61H 21/00; A61H 2205/022; A61H 2201/1253; A61H 9/0071

(57) ABSTRACT

A method is described for treatment of aphthous ulcers or canker sores whereby brief high-pressure vacuum is administered to the aphthous ulcer, resulting in swelling and minor hemorrhage, with immediate relief of pain and hastening of healing of the ulcer.

This application claims the benefit and priority date of U.S. Provisional Patent Application No. 62/577885, EFS ID 30782438, and confirmation number 9796, filed Oct. 27, 2017, and titled “Method and Device for Treatment of Aphthous Ulcers”.

### FIELD

The present invention relates to devices, systems, and processes useful for relieving symptoms associated with oral ulcers, specifically aphthous ulcers (“canker sores”), and for speeding healing of aphthous ulcers (“canker sores”).

### BACKGROUND OF THE INVENTION

The present invention relates generally to a method of treating aphthous ulcers by local application of high-pressure suction or vacuum to the oral mucosa such that said apthous ulcer experiences nearly a complete vacuum (negative one atmosphere of pressure) for a duration sufficient enough to cause swelling of the ulcer bed and surrounding oral mucosa, redness of the ulcer bed and surrounding oral mucosa, and also petechial or microscopic hemorrhage into the mucosal or submucosal tissues of the ulcer or its surrounding tissues, possibly accompanied by minor hemorrhage from the ulcer surface. Such petechial, microscopic, or frank hemorrhage can deposit clotting factors, platelets, and growth factors into the wound, thereby speeding healing and immediately relieving pain.

Aphthous ulcers, commonly known as canker sores, are erosions of the mucous membrane or oral mucosa, involving breakdown of the cellular lining of the mouth and superficial elements of the underlying soft tissue. Although the etiology of aphthous ulcers is unknown, they have not been attributed to infections agents, and many believe they have an immunologic origin. They are a vexing problem. Although they are self-limited and usually resolve without any treatment, they are common, experienced by ˜4-60% of people, are painful, and can last up to two weeks or more, during which the afflicted individual experiences profound lack of enjoyment of food and overall discomfort. They are often recurrent, and can occur throughout life.

The goal of treatment is elimination of the ulcer and symptomatic relief. There are a number of topical and naturopathic remedies for aphthous ulcers, most of which have not been shown to alter their natural history. There are some medical procedures, like cauterization, that can be effective but are expensive and require trained healthcare personnel to deliver. This can be done with topical agents like silver nitrate, sulfuric acid, debacterol, or laser. Topical corticosteroids and nonsteroidal antiflammatory agents have also been shown to provide relief and hasten ulcer healing.

The present invention is a device and method for treating aphthous ulcers that results in immediate symptom relief and hastens healing of the ulcer.

### REFERENCES CITED

### U.S. Patent Documents

U.S. Pat. No. 5,938,658

U.S. Pat. No. 5,968,005

U.S. Pat. No. 6,104,952

U.S. Pat. No. 6,161,548

U.S. Pat. No. 8,128,581 B2

20110160634 A1

20120207184 A1

20130066241 A1

20150024070 A1

WO2006073700A2

WO2006073700 A3

### Other Publications

Argenta L, Morykwas M. Vacuum assisted closure: A new method for wound control and treatment: Clinical experience. Ann Plast Surg. 1997;38:563-76. [PubMed: 9188971]

### SUMMARY

Described in detail herein is the method and an exemplary apparatus to achieve relief of pain and healing of aphthous ulcers by direct application of suction to the ulcer or to the area surrounding the ulcer or within the ulcer so that a superficial layer of blood is extracted into the ulcer, depositing platelets, clotting factors, and growth factors in the ulcer, congealing the exposed surface of the ulcer and providing for healing. The suction that is applied is strong, so that mild to moderate swelling of the mucosa of the mouth and adjacent soft tissues is present even after application for a brief period (e.g., less than 5 seconds). The pressure of the vacuum applied should be strong, e.g., in the range of −0.5 to −1.0 atmospheres of pressure. In order to be able to generate this vacuum force sufficient to applied to oral aphthous ulcers that might be up to 2 cm in diameter, a vacuum chamber of at least 2 cubic centimeters is required, with no upper limit of vacuum chamber size.

### BRIEF DESCRIPTION OF THE DRAWINGS

FIG. 1 is a cutaway longitudinal perspective of the suction or vacuum device, comprising a syringe chamber 1, a piston 2, a spring 3, a tab on the proximal end of the syringe 4, stops 5 within the piston chamber to prevent disengagement of the plunger, and a cup 6 at the distal tip of the syringe that is used to engage the oral mucosa surrounding the aphthous ulcer.

FIG. 2 is also a cutaway longitudinal perspective of the suction or vacuum device, with a larger cup 6 at its distal tip.

FIG. 3 is a similar longitudinal cutaway view of the suction or vacuum device, with a straight extension 7 from the syringe chamber 1 to the distal tip 6.

FIG. 4 is a cutaway longitudinal view of the suction or vacuum device with a curved extension 7 from the syringe chamber 1 to the cup 6.

### DETAILED DESCRIPTION OF THE PREFERRED EMBODIMENT

Referring to the drawing figures, like reference numerals designate identical or corresponding elements throughout the several figures. The singular forms “a,” “an,” and “the” include plural referents unless the context clearly dictates otherwise. Thus, for example, reference to “a syringe” includes reference to one or more of such syringes, and reference to “the cup” includes reference to one or more of such cups.

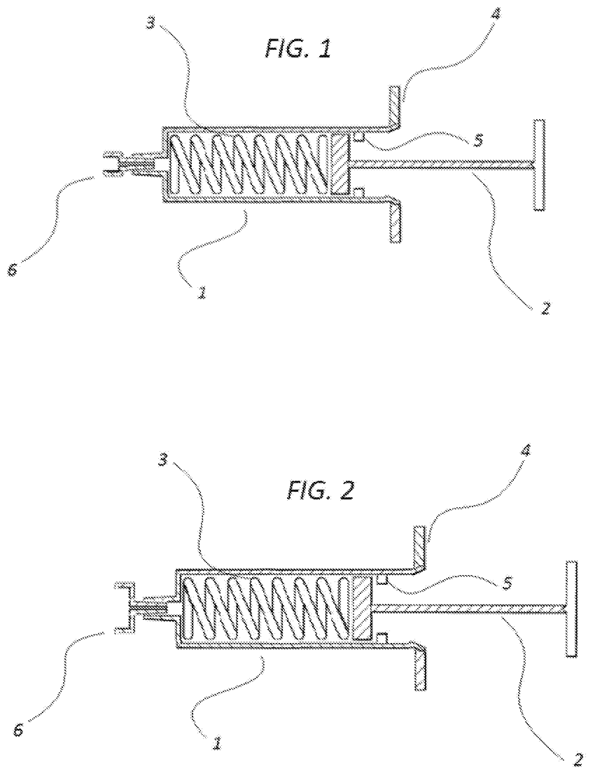

To apply the treatment for aphthous ulcers disclosed herein, a suction apparatus like the one depicted in FIG. 1 is used. The suction apparatus has a proximal end that is held in the hand of the user, and a distal end with a cup whose rim in one embodiment encompasses the peripheral margin of the ulcer. In one exemplary embodiment of the suction apparatus depicted in FIG. 1, the piston 2 is depressed while holding the tabs 4 on the syringe body to fully purge the syringe chamber 1, and then the cup 6 is pressed into contact with the oral mucosa so that the rim of the cup surrounds the ulcer in its entirety, or nearly so, in an air-tight seal. Alternatively, for large ulcers, to minimize discomfort, subtotal sections of the ulcer can be treated, with multiple overlapping treatments applied to treat the entire ulcer. The piston 2 is then released, and the spring 3 pushes the piston out of the back or proximal end of the syringe chamber 1 until it hits stops 5 on the syringe and can't move any further proximally, thereby creating a vacuum or suction within the syringe 1 and cup 6. In this example, the cup 6 has a small diameter (e.g., less than 5 mm). As depicted in the figures, the spring apparatus enables the user to generate suction force by compressing the piston 2 rather than extracting it from the syringe, thereby permitting single hand use. Sufficient suction is administered such that a small amount of blood is extracted from the ulcer to coat the surface of the ulcer where the oral mucosa has broken down. After a brief time, e.g., less than 5 seconds of suction, the user depresses the piston 2 again and releases the vacuum, and removes the suction device. When suction is released and the suction device removed mild to moderate swelling of the treated tissues is apparent immediately, and a small amount of hemorrhage may be apparent as petechial or microscopic spots of hemorrhage within the ulcer, or even a small amount (less than one drop) of frank hemorrhage in the ulcer, or in the cup 6 of the suction device. That sequence comprises the treatment method. Note that in this preferred embodiment the vacuum is generated using a syringe chamber and piston, but that other methods of generating suction such as for example a roller pump or Venturi effect are envisioned and incorporated herein.

FIG. 2 shows a different embodiment of the suction device, wherein said suction device has a large (e.g., less than 2 cm) cup 6 at its distal end.

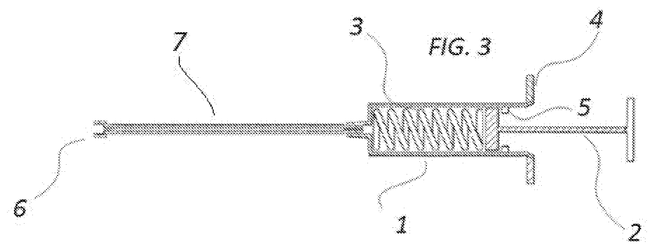

FIG. 3 shows yet another embodiment of the suction device, wherein said device has a straight extension tube component 7 between the cup 6 and syringe chamber 1.

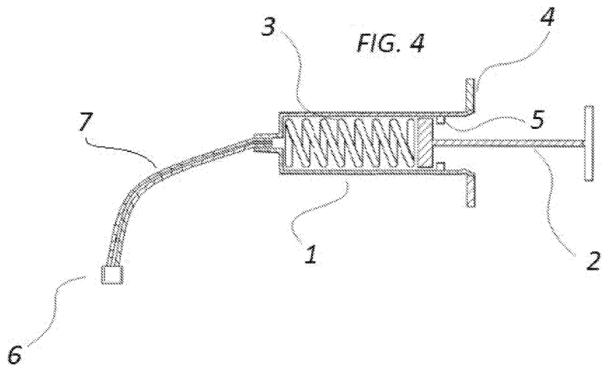

FIG. 4 show still another embodiment of the suction device, wherein said device has a curved extension tube component 7 between the cup 6 and syringe chamber 1.

What is claimed is:

1. A method for treating ulcers of the oral mucosa accomplished by creating a high vacuum pressure (between minus 0.5 and minus 1.0 atmospheres of vacuum pressure) using a hand-held device comprising a pump mechanism and applying the suction using a cup interface from the device to the oral mucosa such that vacuum is applied to part of all of the ulcer surface.

2. A method for treating ulcers of the oral mucosa of claim 1 where the vacuum chamber is at least 2 cubic centimeters in volume.

3. A method for treating ulcers of the oral mucosa of claim 1 where the treatment is applied for less than 5 seconds.

4. A method for treating ulcers of the oral mucosa of claim 1 where mild to moderate soft tissue swelling is apparent immediately after termination of the treatment application.

5. A method for treating ulcers of the oral mucosa of claim 1 where petechial hemorrhage of the ulcer surface results from the treatment.

6. A method for treating ulcers of the oral mucosa of claim 1 where extraction of a small amount (less than a few drops) of frank blood is achieved.
